(19) United States
(12) Patent Application Publication
(10) Pub. No.: US 2012/0033936 A1
(43) Pub. Date: Feb. 9, 2012

(54) REPRODUCING APPARATUS OF VIDEO AND AUDIO INFORMATION

(76) Inventor: Hiroto MIZOUCHI, Osaka (JP)

(21) Appl. No.: 13/196,100

(22) Filed: Aug. 2, 2011

(30) Foreign Application Priority Data
Aug. 3, 2010 (JP) 2010-174129

(51) Int. Cl. H04N 5/91

(52) U.S. Cl. 386/230; 386/E05.003

(57) ABSTRACT

A reproducing apparatus capable of reproducing audio and/or video information indicating audio and video, includes a display unit configured capable of displaying information related to reproduction of the audio and video information, and a display controller configured to control the display unit. The display controller has plural display control modes, selects one display control mode from the plural display control modes according to control state of reproducing operation of the audio and video information, and controls the display unit according to the selected display control mode. The plural display control mode include a first display mode which controls emission state of all of the light-emitting diodes to display time information related to reproduction of audio and video information on the display unit, and a second display mode which controls emission state of a part of the light-emitting diodes to display, on the display unit, information representing that the reproducing apparatus is in operation to reproduce the audio and video information.

### BACKGROUND OF THE INVENTION

1. Technical Field

The present invention relates to a reproducing apparatus capable of reproducing video and audio information representing video and/or audio, more particularly to a reproducing apparatus having a display unit capable of displaying information related to a state of reproducing control.

2. Related Art

In recent years, public awareness of prevention of global warming and a reduction in CO2 has been heightened, and thus various electronic products require improvement in energy-saving performances. An audio and video reproducing apparatus is required to improve the energy-saving performance. In general, the audio and video reproducing apparatus has a display unit for displaying a state of reproducing control, and techniques for reducing power consumption in such a display unit has been conventionally researched and developed (for example, JP-A-2005-109953).

For example, the reproducing apparatus disclosed in JP-A-2005-109953 has an object to reduce power consumption of a display unit. The reproducing apparatus has an FL (fluorescent tube) display 14 as a display unit. The reproducing apparatus changes brightness of the FL display 14 at the start of the reproduction and after elapse of a certain period of time from the start of the reproduction.

As a display unit to be used in a reproducing apparatus, there is a display composed of a light-emitting diode (LED) as well as a display composed of a plurality of fluorescent tubes (FL). The fluorescent tube (FL) and the light-emitting diode (LED) are different in mechanism of light emission, and thus also different in control for display. The display unit composed of light-emitting diodes (LED) is also required to reduce more power consumption.

The present invention has an object to provide a reproducing apparatus of reproducing video and audio having a display unit composed of a plurality of light-emitting diodes (LED), that can reduce power consumption in the display unit.

### SUMMARY OF THE INVENTION

A reproducing apparatus of the invention is capable of reproducing audio and/or video information indicating audio and video. The reproducing apparatus includes a display unit that includes plural light-emitting diodes and is capable of displaying information related to reproduction of the audio and video information, and a display controller configured to control the display unit by controlling supply of power to each of the light-emitting diodes to control emission state of each of the light-emitting diodes. The display controller has plural display control modes, selects one display control mode from the plural display control modes according to control state of reproducing operation of the audio and video information, and controls the display unit according to the selected display control mode. The plural display control mode include a first display mode which controls emission of all of the light-emitting diodes to display time information related to reproduction of audio and video information on the display unit, and a second display mode which controls emission of a part of the light-emitting diodes to display, on the display unit, information representing that the reproducing apparatus is in operation to reproduce the audio and video information.

With this configuration, the reproducing apparatus can select one from the plural display control modes and control the display unit according to the state of reproducing control of the audio and video information. Thus it is possible to make the number of light emitting of the light-emitting diodes at one timing (for example, at elapse of predetermined timing from the start of reproduction) smaller than that at the other timing (for example, at start of reproduction) so as to reduce power consumption required for display, during reproduction of the audio and video information.

It is noted that the audio and video information may include only video content or audio content. That is, the reproducing apparatus to which the concept of the invention can apply is required to reproduce at least video or audio.

According to the present invention, the number of light-emitting diodes can be reduced according to a control state at the time of a reproducing operation, so that the power consumption can be reduced.

### BRIEF DESCRIPTION OF DRAWINGS

FIG. 1 is a view illustrating an exemplary configuration of a reproducing apparatus according to an embodiment of the present invention.

FIG. 2 is a view illustrating an exemplary arrangement of light-emitting diodes of a display unit according to the embodiment.

FIGS. 3A to 3F are views illustrating exemplary display of each of display control modes of a display control unit according to the embodiment.

FIGS. 4A to 4F are views illustrating another exemplary display of an in-playback display mode.

FIG. 5 is a view illustrating state transition of the display control mode of the display control unit according to the embodiment.

### DETAILED DESCRIPTION OF PREFERRED EMBODIMENTS

### First Embodiment

One embodiment of the present invention will be specifically described below with reference to the drawings.

### 1. Overview

A reproducing apparatus for video and audio information according to the present embodiment is equipped with a display unit 108 having a plurality of light-emitting diodes. When reproducing video and audio information recorded in an optical disk the reproducing apparatus 100 switches display on the display unit 108 according to a state of reproduction control. Specifically, the reproducing apparatus 100 switches the reproduction control to set the number of light-emitting diodes that emit light in display after the elapse of a predetermined time from start of reproduction to be smaller than that in display at the start of the reproduction. This allows power consumption in the reproducing apparatus to be further reduced.

### 2. Configuration

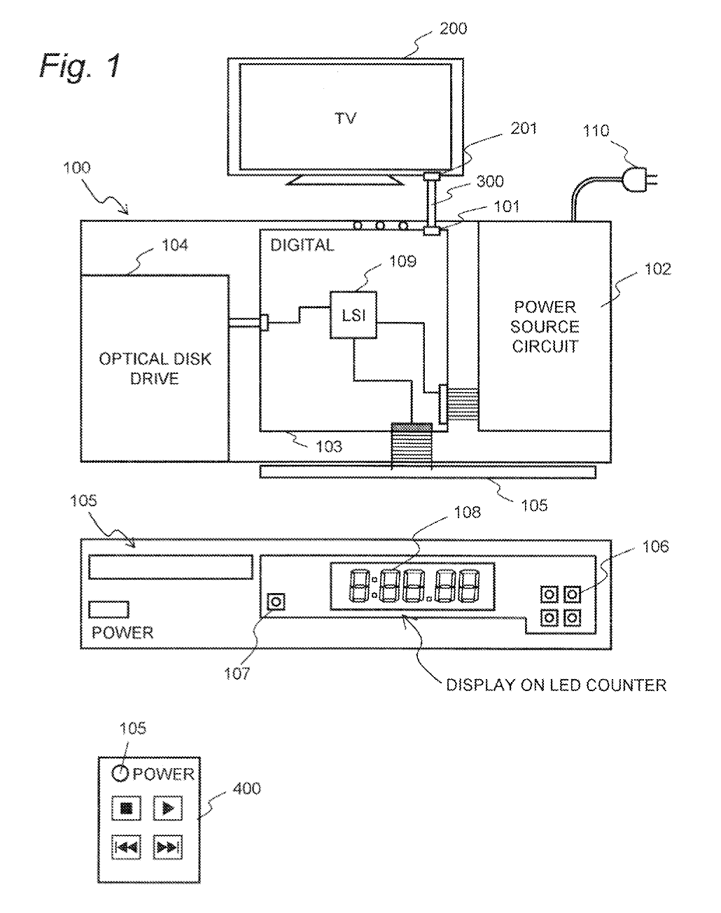

A configuration of a reproducing system for video and audio information according to the embodiment will be described. FIG. 1 illustrates the configuration of the reproducing system for video and audio information. The reproducing system includes a reproducing apparatus 100 and a display device 200. The reproducing apparatus 100 is connected to the display device 200 via a cable 300. The display device 200 is a monitor device for outputting a video and audio signal output from the reproducing apparatus 100, via a display or a speaker. The cable 300 can be realized by an HDMI (High Definition Multimedia Interface) cable and transmits a video signal. and an audio signal. The reproducing apparatus 100 can receive an operation signal from a remote controller 400. The remote controller 400 outputs an operation signal according to an operation from a user. The remote controller 400 has an operating unit on which a power button, a playback button, a stop button, a pause button, a fast-forward button, a rewind button, a skip button and the like are arranged.

A exemplary configuration of the reproducing apparatus 100 will be described. The reproducing apparatus 100 has an optical disk drive 104, a main circuit board 103 mounted with an LSI 109, a front panel 105, an input/output interface 101, and a power source circuit 102.

The optical disk drive 104 can be inserted with an optical disk therein and can read information from the inserted optical disk. The optical disk drive 104 can output video and audio signals read from the optical disk to the LSI 109.

The LSI 109 is a controller for decoding the video and audio information reproduced by the optical disk drive 104 into video and audio signals, and controlling each of units in the reproducing apparatus. The decoding process for the video and audio information and the control process for the each unit can be realized also by combination of individual LSI chips. The control of each unit by the LSI 109 will be described later.

The front panel 105 is a panel provided to a front side of an exterior of the reproducing apparatus. The front panel 105 is provided with operation buttons 106, a remote controller light receiving unit 107, and the display unit 108.

The operation buttons 106 composes an operating unit provided to the reproducing apparatus. As the operation buttons 106, the power button, the playback button, the stop button, the pause button, the fast-forward button, the rewind button and the like are arranged. When operated by a user, the operation buttons 106 transmit an operation signal to the LSI 109.

The remote controller light receiving unit 107 is a light receiving unit for receiving an operation signal from the remote controller 400.

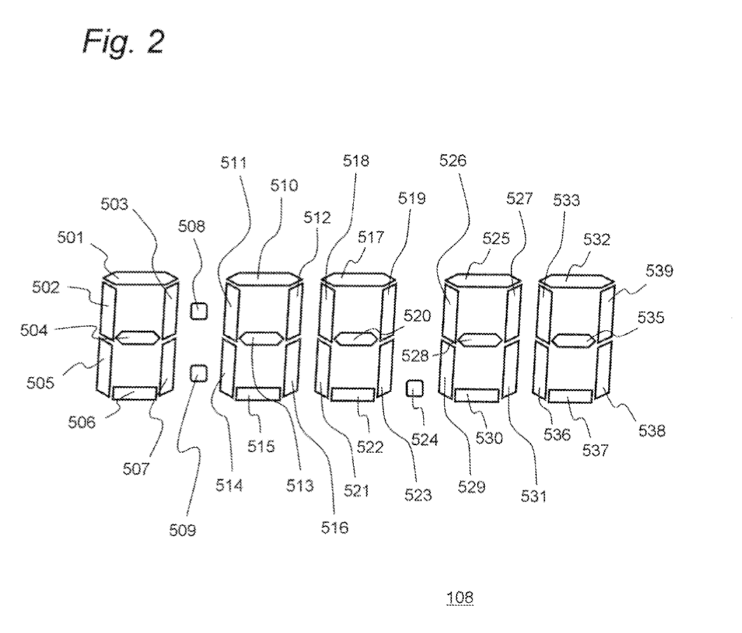

The display unit 108 is display on which the plurality of light-emitting diodes (501 to 538) are arranged as shown in FIG. 2. In the plurality of light-emitting diodes (501 to 538), seven diodes are arranged to be figure-eight shaped so that one digit figure from zero to nine can be displayed. A combination of the seven light-emitting diodes that enables display of one digit figure is called “figure LED set”. It is noted that “LED” is abbreviation of Light Emitting Diode. Five sets of figure LED sets are arranged so that five-digit figure can be displayed. The light-emitting diodes 508 and 509 and light-emitting diode 524 are arranged between the figure LED sets so that hour/minute/second in display of time can be recognized individually.

The input/output interface 101 is an interface for communicating data with the video and audio output apparatus 200.

The power source circuit 102 is a circuit for supplying a power from an AC cable connected to a commercial power source to the respective units. The power source circuit 102 supplies a power to the respective units according to control signals from the LSI 109.

### 3. Example of Display Pattern

The LSI 109 switches the display control mode for controlling the display unit 108 according to an operating state (reproduction control state) of the reproducing apparatus 100. The following will describe display examples of the display unit 108 in each display control mode.

In the reproducing apparatus 100 according to the embodiment, the display control mode includes a plurality of modes, such as “start-up display mode”, “stop display mode”, “READ display mode”, “playback time display mode,” “in-playback display mode”, “special playback display mode,” and “power-off process display mode”.

When the power of the reproducing apparatus is OFF, no power is supplied to the light-emitting diodes, so that nothing is displayed on the display unit 108. Such a state of the display unit 108 at the time when the power of the reproducing apparatus 100 is OFF is called “no display”.

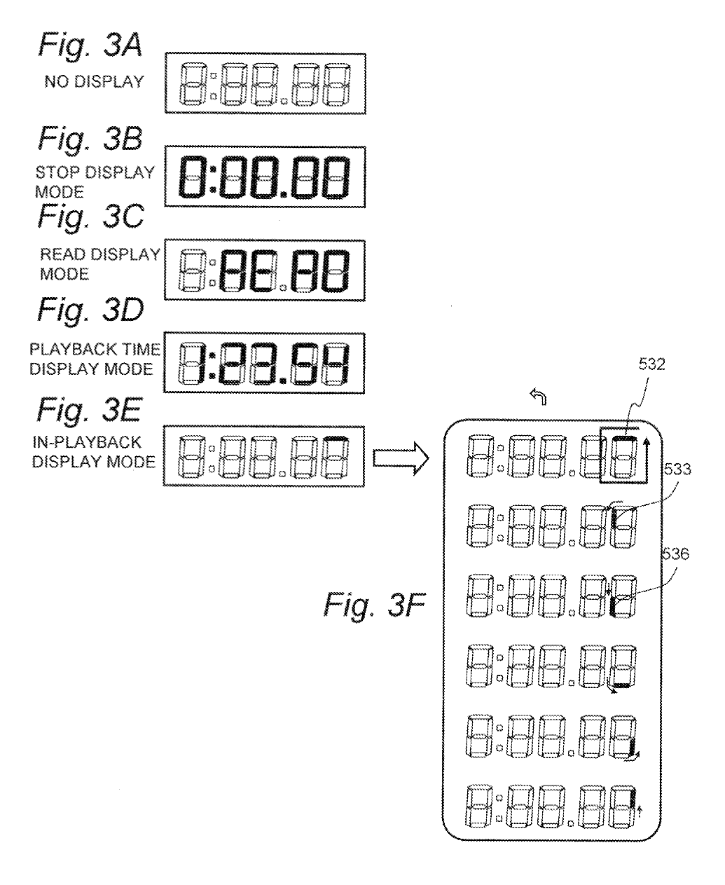

With reference to FIGS. 3A to 3F, the display examples in each display control mode will be specifically described below.

### (0) No Display

This is not the display control mode. When the power of the reproducing apparatus is OFF, no power is supplied to the light-emitting diodes, and nothing is displayed on the display unit 108 as shown in FIG. 3A.

### (1) Stop Display Mode

In the stop display mode, information representing a stop state of the reproducing apparatus 100 is displayed. For example, in the stop display mode, the LSI 109 supplies a power from the power source circuit 102 to the light-emitting diodes as shown in FIG. 3B, and “0:00. 0” is displayed on the, display unit 108.

### (2) READ Display Mode

In the READ display mode, information representing that the reproducing apparatus 100 is in a state in which the optical disk is being read by the optical disk drive 104 is displayed. For example, in the READ display mode, the LSI 109 supplies a power from the power source circuit 102 to the light-emitting diodes as shown in FIG. 3C to display the text “READ” is displayed on the display unit 108.

### (3) Playback Time Display Mode

In the playback time display mode, information representing elapsed time for the reproduction of video and audio information is displayed. For example, in the playback time display mode, the LSI 109 supplies a power from the power source circuit 102 to the light-emitting diodes as shown in. FIG. 3D to display a certain time “1:23.54” on the display unit 108. FIG. 3D illustrates one example of display showing “1 hour 23 minutes 54 seconds” as time information. In the playback time display mode, the LSI 109 counts the time as the playback time passes. Therefore, the LSI 109 causes the display unit 108 to display “1:23.55” one second after the display of FIG. 3D, for example. In the example shown in FIG. 3D, it is configured to cause all light emitting diodes to emit light even though the upper digit(s) is(are) zero. For example, in the case of 0 hour 00 minute 01 second, the display unit 108 is controlled to display the characters “0:00.01”. However displaying “0” of the upper digits causes increase of power consumption. Thus the light-emitting diodes for “0” of the upper digits may be controlled not to emit light. In this case, only the diodes 539 and 538 are controlled to emit light to display the figure “1”.

### (4) In-Playback Display Mode

In the in-playback display mode, information representing that the reproducing apparatus 100 is reproducing video and audio information is displayed. For example, in the in-playback display mode, the LSI 109 supplies a power from the power source circuit 102 to a part of light-emitting diodes as shown in FIG. 3E, causing only one light-emitting diode to emit light on the display unit 108. In the example shown in FIG. 3E, only the light-emitting diodes contained in the figure diode set including the light-emitting diodes 532, 533, . . . are supplied with power. The LSI 109 changes the light-emitting diode to emit light on the display unit 108 every second in order to allow the user to easily understand that the playback (reproduction) is being performed.

For example, as shown in FIG. 3F, the LSI 109 makes the light-emitting diode 532 to emit light, and then light-emitting diode 533 to emit light. Thereafter, the LSI 109 makes the light-emitting diode 536 to emit light. The LSI 109 allows the light-emitting diodes to emit light sequentially while switching them as shown in FIG. 3F.

### 4. Operation and Transition of the Display Control Mode

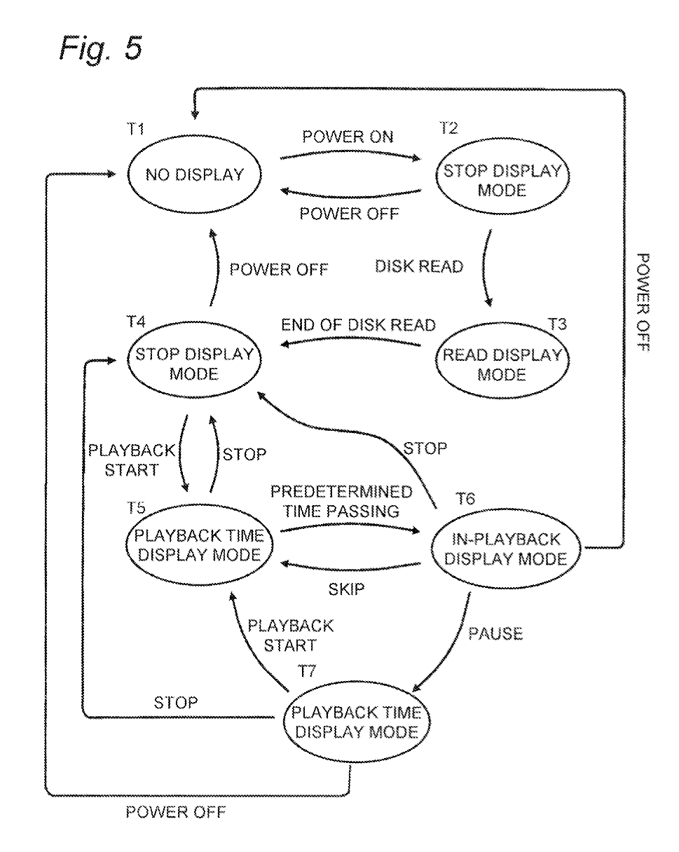

With reference to FIG. 5, the operation of the reproducing apparatus 100 and the transition of the display control mode will be described. In the following description, it is assumed that the reproducing apparatus 100 is connected to a commercial power source and is connected to the video and audio output apparatus 200. At first, the power of the reproducing apparatus 100 is OFF. That is, at first, the display unit 108 is in the state of “no display” (T1).

In this state, when the user presses down the power button of the operation buttons 106, the LSI 109 turns on the power of the reproducing apparatus 100. When the power of the reproducing apparatus 100 is turned on, the LSI 109 switches the display control mode to the “stop display mode” (T2). At this time, “0:00.0” is displayed on the display unit 108 (see FIG. 3B).

The LSI 109 detected whether an optical disk is inserted in the optical disk drive 104. When the optical disk is not inserted in the optical disk drive 104, the LSI 109 stands by in the “stop display mode”. On the other hand, when the optical disk has been already or just inserted in the optical disk drive 104, the LSI 109 starts reading of the optical disk. The reading of the optical disk is performed for checking whether reproduction of the inserted optical disk can be performed. When the reading of the optical disk is started, the LSI 109 switches the display control mode to the “READ display mode” (T3). At this time, “READ” is displayed on the display unit 108 (see FIG. 3C).

When the reading of the optical disk is completed, the LSI 109 switches the display control mode to the “stop display mode” (T4). At this time, “0:00.0” is displayed on the display unit 108 (see FIG. 3B).

In this state, when an instruction for starting the reproduction is received from the user (when receiving an operation signal by the playback button of the operation buttons 106 or the playback button of the remote controller 400), the LSI 109 reads video information from the optical disk and decodes the video information so as to output a video signal to the video and audio output apparatus 200, thus reproducing a video content recorded in the optical disk.

At the start of the reproduction, the LSI 109 switches the display control mode to the “playback time display mode” (T5). This causes the display unit 108 to display the playback time.

When a predetermined time (for example, five seconds) elapses from the start of the reproduction, the LSI 109 switches the display control mode to the “in-playback display mode” (T6). At this time, the display unit 108 is in a state that only one light-emitting diode emits light as shown in FIGS. 3E and 3F.

When a skip operation (for example, fast forward or rewind) is performed by user's operation, the LSI 109 skips a video content, and returns the display control mode to the “playback time display mode” (T5). When a predetermined time elapses from the skip operation, the LSI 109 again switches the display control mode to the.“in-playback display mode” (T6).

When the pause operation is performed by user's operation, the LSI 109 pauses a video content, and returns the display control mode to the “playback time display mode” (T7). At this time, the playback time to be displayed on the display unit 108 is stopped. When receiving the instruction for starting the reproduction (playback) from the user, the LSI 109 changes the state while keeping the display control mode in the “playback time display mode” (T5). That is, the playback time is displayed on the display unit 108, and counting is started. Thereafter, when a predetermined time elapses, the display control mode is again switched to the “in-playback display mode” (T6).

The above description describes one example of the operation and transition in the reproducing apparatus 100.

### 5. Conclusion

As described above, the reproducing apparatus 100 of the present embodiment includes a display unit 108 which includes plural light-emitting diodes 501, 502, and can display information related to reproduction of audio and video information, and a LSI 109 which controls the display unit 108 by controlling supply of power to each of the light-emitting diodes 501, 502, . . . to control emission of each of the light-emitting diodes 501, 502, . . . . The LSI 109 has plural display control modes, selects one display control mode from the plural display control modes according to control state of reproducing operation of the audio and video information, and controls the display unit 108 according to the selected display control mode. The plural display control mode include the playback time display mode (first display mode) which controls emission state of all of the light-emitting diodes 501, 502, . . . to display time information related to reproduction of audio and video information on the display unit 108, and the in-playback display mode (second display mode) which controls emission state of a part of the light-emitting diodes 501, 502, to display, on the display unit 108, information representing that the reproducing apparatus is in operation to reproduce audio and video information.

With this configuration, the reproducing apparatus 100 can select one from the plural display control modes and control the display unit 108 according to the state of reproducing control of the audio and video information. Thus it is possible to make the number of the light-emitting diodes to emit at one timing (for example, at elapse of predetermined timing from the start of reproduction) smaller than that at the other timing (for example, at start of reproduction) so as to reduce power consumption required for display, during reproduction of the audio and video information.

Specifically, the reproducing apparatus 100 according to the embodiment displays the playback time in the playback time display mode (first display mode) on the display unit 108, at the start of the reproduction. Then the reproducing apparatus 100 stops the display of the playback time and display information indicating that the playback (reproduction) is being performed in the in-playback time display mode (second display mode) by causing only some of al light-emitting diodes to emit light, after a predetermined time elapses from the start of the reproduction.

In this manner, the display of the playback time is stopped after the predetermined time elapsed from the start of the playback (reproduction), making less light-emitting diodes emit, in the in-playback time display mode (second display mode). This makes it possible to further save the power consumption of the light-emitting diodes. During the playback of video and audio information a part of all the light-emitting diodes are controlled to emit light, and thus it is possible to prevent the user from faultily recognizing that the power of the reproducing apparatus 100 is OFF.

In the embodiment, when the power of the reproducing apparatus 100 is ON, the display unit 108 is controlled to make a part of all light-emitting diodes emit light to display on the display unit 108 predetermined information for representing that the power is on. This arrangement allows the user to recognize that the power of the reproducing apparatus 100 is ON.

Further, in the embodiment, the number of light-emitting diodes to emit light on the display unit 108 is reduced during the reproduction (playback) of the video and audio information (after the predetermined time elapses from the start of the reproduction). Hence, the power consumption of the reproducing apparatus 100 during the reproduction operation as the main function can be further reduced, thereby reducing rated power of the apparatus itself.

### Other Embodiments

As the embodiment of the present invention, the above embodiment has been described. The present invention, however, is not limited to the above embodiment, and can be realized in other embodiments. Therefore, other embodiments of the present invention will be described below all together.

In the first embodiment, in the “in-playback display mode”, one light-emitting diode is controlled to emit light. However, the present invention is not limited to such a control. In the “in-playback display mode”, the number of the light-emitting diodes that emit light may be smaller than that in the “playback time display mode”. When the number of light-emitting diodes to emit light is set to 1 like the above embodiments, the power consumption can be significantly reduced.

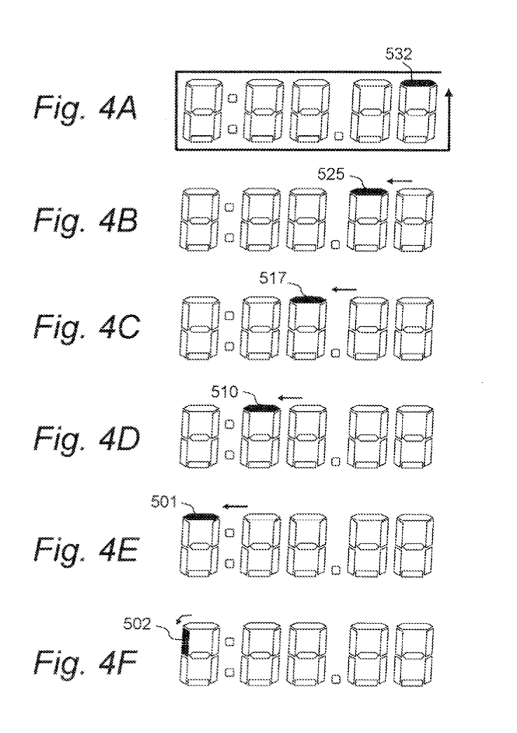

In the first embodiment, in the “in-playback display mode”, the light-emitting diodes are controlled to sequentially emit light as shown in FIGS. 3E and 3F. However, the control method of the light-emitting diode is not limited to this, and the light-emitting diodes may be controlled to sequentially emit light as shown in FIGS. 4A to 4F.

In the case shown in FIG. 3F, one light-emitting diode is sequentially switched to emit light, in one figure LED set. On the contrary, in the case shown in FIGS. 4A to 4F, over plural figure LED sets, one light-emitting diode to emit is sequentially switched. The reason why the position of the light-emitting diode to emit is changed in this way is that if the position of the light-emitting diode to emit is not changed, a user may faultily recognize it as warning display. Changing the position of the light-emitting diode to emit allows life of parts in the display unit 108 to be lengthen. Further, changing the position of the light-emitting diode to. emit allows the user to easily recognize that audio and video information is being reproduced.

In the case of FIGS. 4A to 4F, the light-emitting diodes may be controlled to emit light in the following order:

light-emitting diodes 532→525→517→510→501→502→505→506→515→522→530→537→538→539→532→repeat similarly, hereinafter.

In the first embodiment, in the “playback time display mode”, as shown in FIG. 3D, the playback time is shown by a format of hour/minute/second. However, the display format is not limited to this, and a counting-up value may be displayed instead of the playback time. The counting-up value may be expressed by only second, or a natural number that is counted up from 0.

Further, the following control may be added to that of the first embodiment. For example, an indication representing “STOP” may be displayed in the “stop display mode” of the state T4 as shown in FIG. 5. A “STILL display mode” may be provided during the transition from the “in-playback display mode” at the state T6 to the “playback time display mode” at the state T7. In this case, before the transition to the state T7, an indication “representing “STILL” is displayed on the display unit 108. Similarly, at the time of the transition from the “playback time display mode” at the state T7 to the “playback time display mode” at the state T5, a “PLAY display mode” may be inserted. In this case, before the transition to the state T5, an indication representing “PLAY” is displayed on the display unit 108.

By displaying the information representing “STOP”, “PLAY” or “STILL” at the time of the state transition of the reproducing apparatus 100, the user can confirm the operating state of the reproducing apparatus 100. Further, when the user performs an operation to display a reproducing state (playback state) of the reproducing apparatus 100 as GUI display on a monitor screen of the video and audio output apparatus 200, the display on the display unit 108 can be returned to the “playback time display mode” in synchronization with the display of GUI. Thereafter, similarly to the above control, the display control mode is again switched to the “in-playback display mode” in synchronization with the elapse of the predetermined time or the end of the display of GUI, so that the power consumption of the display unit 108 can be saved.

### INDUSTRIAL APPLICABILITY

The present invention can be applied to a player or a recorder capable of reproducing video and audio content, that has a display unit capable of displaying information representing a reproducing state.

What is claimed is:

1. A reproducing apparatus capable of reproducing audio and/or video information indicating audio and video, comprising:
a display unit that includes plural light-emitting diodes and is capable of displaying information related to reproduction of the audio and video information; and
a display controller configured to control the display unit by controlling supply of power to each of the light-emitting diodes to control emission state of each of the light-emitting diodes,
wherein the display controller has plural display control modes, selects one display control mode from the plural display control modes according to control state of reproducing operation of the audio and video information, and controls the display unit according to the selected display control mode,
the plural display control mode include a first display mode which controls emission state of all of the light-emitting diodes to display time information related to reproduction of audio and video information on the display unit, and a second display mode which controls emission state of a part of the light-emitting diodes to display, on the display unit, information representing that the reproducing apparatus is in operation to reproduce the audio and video information.

2. The reproducing apparatus according to claim 1, wherein
the first display mode is a mode which supplies power to the plural light-emitting diodes in parallel, and
the second display mode is a mode which supplies power to only one of the plural light-emitting diodes.

3. The reproducing apparatus according to claim 1, wherein
the first display mode is a mode which makes at least two of the plural light-emitting diodes emit light at the same time, and
the second display mode is a mode which makes only one of the plural light-emitting diodes emit light at the same time.

4. The reproducing apparatus according to claim 1, wherein
the display unit has plural diode sets arranged therein, each diode set including plural “light-emitting diodes arranged in figure eight shape, and
the second display mode is a mode which causes only one light-emitting diode sequentially selected from light-emitting diodes included in the plural diode sets to emit light at the same time.

5. The reproducing apparatus according to claim 1, wherein the display controller controls the display unit in the first display mode at the start of the reproduction of the audio and video information, and controls the display unit in the second display mode when a predetermined time elapses from the start of the reproduction of the audio and video information.

6. The reproducing apparatus according to claim 1, further comprising a receiving unit configured to receive an instruction for reproduction control from a user,
wherein the display controller controls the display unit in the first display mode when receiving an instruction for reproduction from the user, and controls the display unit in the second display mode when a predetermined time elapses from the receiving the instruction from the user.

7. The reproducing apparatus according to claim 1, wherein the display controller controls the display unit to display information while power of the reproducing apparatus is ON.

8. The reproducing apparatus according to claim 1, wherein the number of light-emitting diodes to be controlled during a unit time in the second display mode is smaller than that in the display modes other than the second display mode.
